(19) United States
(12) Patent Application Publication
(10) Pub. No.: US 2006/0131843 A1
(43) Pub. Date: Jun. 22, 2006

(54) AIR BAG MODULE

(75) Inventors: William M. Sherwood, Royal Oak, MI (US); Jeffrey S. Vinton, Farmington Hills, MI (US); Baohua Xiao, Canton, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD GLOBAL TECHNOLOGIES, LLC, Dearborn, MI (US)

(21) Appl. No.: 10/905,234

(22) Filed: Dec. 22, 2004

(51) Int. Cl. B60R 21/20

(52) U.S. Cl. 280/728.3

(57) ABSTRACT

An air bag module for a motor vehicle. The air bag module includes a housing, an air bag, an inflator, and a tear panel having a weakened area. The tear panel directs deployment of the air bag away from a vehicle occupant before the weakened area tears.

### BACKGROUND OF THE INVENTION

1. Field of the Invention

The present invention relates to an air bag module for a motor vehicle, and more particularly to an air bag module having a tear panel that directs deployment of an air bag.

2. Background Art

Motor vehicles may include an air bag deployment system adapted to deploy an air bag in response to a vehicle impact event. If the air bag is inflated when a vehicle occupant is out of position, such as when the occupant is located close to an air bag module, the occupant may interfere with air bag deployment. As a result, the air bag may be mispositioned and may not provide optimal protection.

Previously, air bag deployment systems were provided with venting means to reduce the pressure of the air bag cushion during deployment to reduce potentially adverse effects due to an out-of-position occupant. Such vented systems require complicated manufacturing and/or sensing systems and do not provide optimal protection when the vehicle occupant is out of position.

Before applicant's invention, there was a need for an improved air bag deployment module for a motor vehicle. In addition, there was a need for an air bag module that provides improved air bag deployment to improve occupant safety. In addition, there was the need for an air bag module that provides a controlled load path when an occupant is out of position or otherwise affects air bag deployment. Moreover, there was a need for an air bag module that fully deploys an air bag regardless of an occupant's position. Problems associated with the prior art as noted above and other problems are addressed by applicant's invention as summarized below.

### SUMMARY OF THE INVENTION

According to one aspect of the present invention, an air bag module for a motor vehicle is provided. The air bag module includes a housing, an air bag, an inflator, and a tear panel. The housing is configured to be disposed proximate the motor vehicle. The air bag is disposed proximate the housing. The inflator is configured to provide an inflator gas to inflate the air bag from a stored condition to a deployed condition. The tear panel is disposed proximate the housing and is adapted to tear when the air bag is actuated toward the deployed condition. The tear panel directs deployment of the air bag away from a vehicle occupant before the tear panel tears, thereby improving air bag deployment and occupant safety by providing a controlled air bag load path for various occupant positions.

The tear panel may include a first end portion and a second end portion disposed opposite the first end portion. The first and second end portions may be coupled to the housing when the air bag is in the stored condition. The tear panel may include first and second unattached edges extending between the first and second end portions. The first and second end portions may cooperate with the housing to define first and second openings before the tear panel tears. The first and second openings may be disposed opposite each other.

The tear panel may include a weakened area. The weakened area may extend between the first or second unattached edges. The weakened area may include a tear initiator adapted to tear before an adjacent portion of the weakened area. A first tear initiator may be disposed proximate the first opening. A second tear initiator may be disposed proximate the second opening.

According to another aspect of the present invention, an air bag module for a motor vehicle is provided. The air bag module includes a housing, an air bag, an inflator, and a tear panel. The housing is configured to be mounted on the motor vehicle. The air bag is disposed proximate the housing. The inflator is configured to provide an inflator gas to inflate the air bag from a stored condition to a deployed condition. The tear panel is disposed proximate the housing and includes a weakened area and first and second unattached edges. The weakened area is adapted to tear when the air bag is actuated toward the deployed condition. The first and second unattached edges cooperate with the housing to define first and second openings, respectively, when the air bag is in the stored condition. The tear panel directs deployment of the air bag through the first and second openings and away from a vehicle occupant before the weakened area tears.

The housing may include a set of retaining features adapted to receive the tear panel. Each member of the set of retaining features may be configured as a hook.

The tear panel may include a set of attachment slots. Each member of the set of attachment slots may be adapted to engage a member of the set of retaining features before the weakened area tears. At least one weakened area may be disposed proximate each member of the set of attachment slots to permit the attachment slots to disengage from the retaining features.

According to another aspect of the present invention, an air bag module for a motor vehicle is provided. The air bag module includes a housing, an air bag, an inflator, and a tear panel. The housing is configured to be disposed proximate the motor vehicle. The air bag is disposed proximate the housing. The inflator is configured to provide an inflator gas to inflate the air bag. The tear panel includes first and second coupling portions and a weakened area. The first and second coupling portions are disposed proximate the housing when the air bag is deflated. The weakened area is adapted to tear when the air bag is inflated. The tear panel extends along an arcuate path between the first and second coupling portions and cooperates with the housing to define first and second openings through which the air bag deploys before the weakened area tears.

The tear panel may include first and second unattached edges extending between the first and second coupling portions. The first and second unattached edges may cooperate with the housing to define the first and second openings.

The first unattached edge may be disposed opposite the second unattached edge. The first coupling portion may be disposed opposite the second coupling portion.

The air bag may include a first portion and a second portion. The first portion extend through the first opening and the second portion may extend through the second opening before the air bag is inflated to facilitate deployment of the air bag away from a vehicle occupant before the weakened area tears.

The tear panel may include an inner surface and an outer surface disposed opposite the inner surface. The first and second portions of the air bag may be disposed proximate the outer surface before the air bag is inflated.

### BRIEF DESCRIPTION OF THE DRAWINGS

FIG. 1 is a fragmentary side view of a vehicle having an air bag module in accordance with one embodiment of the present invention.

FIG. 2 is a perspective view of the air bag module shown in FIG. 1.

FIG. 3 is a perspective view of another embodiment of the air bag module.

FIG. 4 is a perspective view of the air bag module of FIG. 3 with the air bag inflated through first and second openings.

FIGS. 5A-5F are exemplary plan and perspective views depicting the deployment of an air bag.

### DETAILED DESCRIPTION OF THE PREFERRED EMBODIMENT(S)

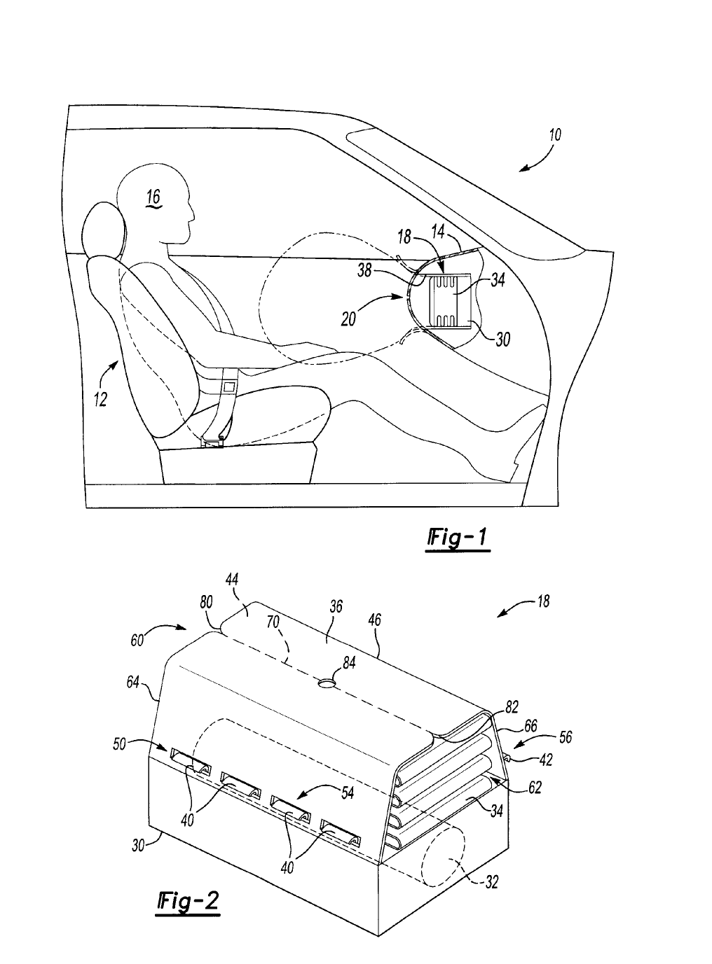

Referring to FIG. 1, a side view of a vehicle 10 is shown. The vehicle 10 includes a seat assembly 12 and an interior trim panel 14. The seat assembly 12 is adapted to receive an occupant 16. The interior trim panel 14 is adapted to conceal an air bag module 18 prior to deployment of an air bag. For example, the interior trim panel 14 may include one or more tear seams or deployment doors 20 adapted to permit deployment of an air bag into the vehicle passenger compartment. In the embodiment shown, the interior trim panel 14 is configured as an instrument panel. Alternatively, the interior trim panel 14 and air bag module 18 may be disposed proximate a vehicle steering wheel.

Referring to FIG. 2, the air bag module 18 is shown in more detail. The air bag module 18 includes a housing 30, an inflator 32, an air bag 34, and a tear panel 36.

The housing 30 is adapted to be disposed proximate the vehicle 10. For example, the housing 30 may be disposed proximate a steering wheel mount or proximate an instrument panel structure. In the embodiment shown, the housing 30 is coupled to an interior surface of the instrument panel via a chute 38 that is disposed near the deployment doors 20. In addition, the housing 30 may include one or more retaining features adapted to engage the tear panel 36. In the embodiment shown, the housing 30 includes a first set of retaining features 40 and a second set of retaining features 42. The retaining features may have any suitable configuration. In the embodiment shown, the retaining features are configured as hooks.

The inflator 32 is adapted to provide an inflation gas to the air bag 34. The inflator 32 may be disposed in any suitable location. In the embodiment shown, the inflator 32 is disposed proximate the housing 30. Alternatively, the inflator 32 may be spaced apart from the housing 30 and connected to the air bag 34 via a tube.

The air bag 34 may be connected to the inflator 32 in any suitable manner. For example, the air bag 34 may include an attachment feature, such as a plurality of flaps that define a pocket for receiving the inflator 32. The air bag 34 expands from a stored condition to a deployed condition when inflation gas is provided. More specifically, the air bag 34 is deflated and concealed by an interior vehicle surface when in the stored condition and is inflated and positioned between the occupant 16 and the interior vehicle surface when in the inflated condition. In FIG. 1, the air bag 34 is shown in solid lines in the stored condition and is shown in phantom disposed in the deployed condition.

The air bag 34 may have any suitable configuration and may be made of any suitable material. For example, the air bag 34 may have any suitable number of chambers and may include one or more tethers that control the shape the air bag 34 upon deployment. The air bag 34 may be assembled in any suitable manner, such as by stitching, bonding, or with an adhesive. Optionally, the air bag 34 may include a friction-reducing coating disposed on an exterior surface to facilitate deployment.

The tear panel 36 is adapted to direct deployment of the air bag 34. More specifically, the tear panel 36 directs the air bag 34 away from the occupant 16 when the air bag 34 is inflated and before the tear panel 36 is torn or severed.

The tear panel 36 may be made of any suitable material. For example, the tear panel 36 may be made of a flexible material, such as a polymeric material or fabric. Optionally, the tear panel 36 may include a friction-reducing coating disposed on an inner surface 44 or an outer surface 46 to reduce friction between the air bag 34 and the tear panel 36 upon deployment. Alternatively, a portion of the tear panel 36 may be attached to the air bag 34 in any suitable manner, such as by stitching or an adhesive.

The tear panel 36 may be disposed proximate the housing 30. In addition, the tear panel 36 may be coupled to the housing 30 in any suitable manner, such as with fasteners or an adhesive. In the embodiment shown in FIG. 2, the tear panel 36 includes a first end portion 50 and a second end portion 52 disposed opposite the first end portion 50. The first end portion 50 includes a first set of slots 54 and the second end portion 52 includes a second set of slots 56. Each member of the first set of slots 54 is adapted to engage a member of a first set of retaining features 40. Similarly, each member of the second set of slots 56 is adapted to engage a member of a second set of retaining features 42. Alternatively, the housing 30 and tear panel 36 may be configured with one set retaining features and one set of slots, respectively.

The tear panel 36 cooperates with the housing 30 to define a first opening 60 and a second opening 62 before the tear panel 36 is torn or severed. More specifically, the tear panel 36 includes first and second unattached edges 64,66 that extend between the first and second end portions 50,52 to define the perimeter of the first and second openings 60,62. The first and second openings 60,62 may be oriented in any suitable manner. In the embodiment shown, the first and second openings 60,62 are positioned opposite each other to allow the air bag 34 to deploy away from the occupant 16 in opposing first and second lateral directions before the tear panel 36 is torn or severed. As such, the air bag 34 may fully deploy if the occupant 16 is out of position as will be described in more detail below.

The tear panel 36 may include one or more weakened areas 70. The weakened area 70 is adapted to tear or sever when the air bag 34 exerts sufficient force on the tear panel 36. The weakened area 70 may have any suitable configuration and may be disposed in any suitable location. For instance, the weakened area 70 may be a localized region of reduced material thickness or material integrity. In the embodiment shown in FIG. 2, the weakened area 70 is configured as a perforation that extends between the first and second unattached edges 64,66. Alternatively, the weakened area 70 may be disposed proximate the first and/or second sets of slots 54,56 as shown in FIG. 4. As such, the weakened area 70 may be one or more shear lines or shear planes disposed adjacent to each slot and adapted to tear toward the edge of the tear panel 36 when the air bag 34 is deployed.

The weakened area 70 may include one or more tear initiators. The tear initiators are adapted to tear before an adjacent portion of the weakened area 70. In the embodiment shown in FIG. 2, a first tear initiator 80 is disposed proximate the first unattached edge 64, a second tear initiator 82 is disposed proximate the second unattached edge 66, and a third tear initiator 84 is disposed between the first and second unattached edges 64,66 near the center of the weakened area 70. The tear initiators 80,82,84 may have any suitable configuration. For instance, the tear initiators 80,82,84 may be configured as an area of reduced material integrity or an area where material is removed from the tear panel 36, such as a notch, aperture, or area of reduced thickness.

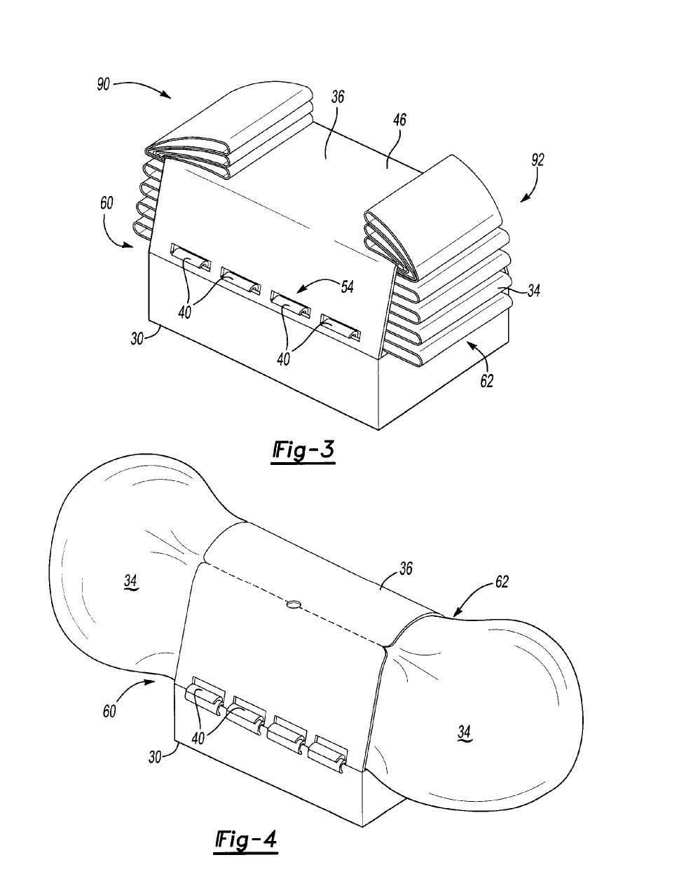

The air bag 34 may be stored in any suitable manner. For example, the air bag 34 may be folded such that it is positioned between the housing 30 and the tear panel 36 as shown in FIG. 2. Alternatively, the air bag 34 may partially extend through the first and second openings 60,62 when in the stored position as shown in FIG. 3. More specifically, the air bag 34 includes first and second portions 90,92 that extend through the first and second openings, 60, 62, respectively. The first and second portions 90,92 are disposed adjacent to the outer surface 46 of the tear panel 36 before the air bag 34 is inflated to help insure that the air bag 34 expands from the first and second openings 60,62 before the tear panel 36 severs.

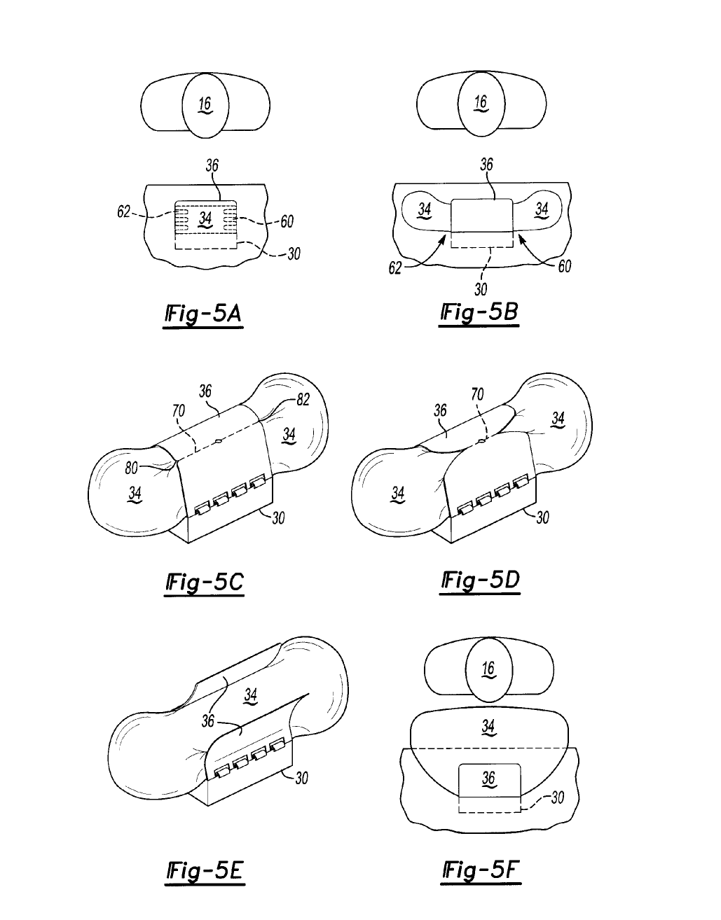

Referring to FIGS. 5A-5F, an air bag deployment sequence is shown in more detail. In these figures, the interior trim panel that conceals the air bag module 18 is not shown for clarity.

In FIG. 5A, the air bag 34 is shown in the stored condition in which the air bag 34 is deflated and the tear panel 36 is not severed.

In FIGS. 5B and 5C, inflator gas is provided to the air bag 34. Since the tear panel 36 has no lateral constraining walls, the air bag 34 expands through the first and second openings 60,62 and away from the occupant 16. The air bag 34 also exerts force against the tear panel 36, placing the tear panel 36 in tension and causing the tear panel 36 to extend along an arcuate path between the first and second end portions 50,52. The tear panel 36 inhibits the air bag 34 from expanding toward the occupant 16 before tearing.

In FIG. 5D, the air bag 34 has a sufficient volume and exerts sufficient force against the tear panel 36 to cause the tear panel 36 to begin to sever. In the embodiment shown, the tear panel 36 includes a weakened area 70 and first and second tear initiators that cause the weakened area to tear away from the first and second openings 60,62.

In FIG. 5E, the weakened area is completely severed and the tear panel 36 is separated into two pieces. In the absence of the impeding force exerted by the tear panel 36, the air bag 34 is permitted to expand toward the occupant 16.

In FIG. 5F, the air bag 34 is in the deployed condition and is adapted to cushion and separate the occupant 16 from the interior trim panel.

The present invention permits the air bag to fully deploy to better protect vehicle occupants. More specifically, the tear panel initially directs the air bag away from an out-of-position occupant. As a result, an out-of-position occupant will not redirect or interfere with air bag inflation and the air bag will provide a controlled load path to cushion the occupant during a vehicle impact event, thereby improving occupant protection. In addition, the weakened area may be positioned on the tear panel to direct deployment of the air bag. As such, the tear panel may direct the air bag to initially contact a desired portion of the occupant or to avoid contact with interior vehicle surfaces.

While the best mode for carrying out the invention has been described in detail, those familiar with the art to which this invention relates will recognize various alternative designs and embodiments for practicing the invention as defined by the following claims.

What is claimed is:

1. An air bag module for a motor vehicle, the air bag module comprising:
a housing configured to be disposed proximate the motor vehicle;
an air bag disposed proximate the housing;
an inflator configured to provide an inflator gas to inflate the air bag from a stored condition to a deployed condition; and
a tear panel disposed proximate the housing and adapted to tear when the air bag is actuated toward the deployed condition;
wherein the tear panel directs deployment of the air bag away from a vehicle occupant before the weakened area tears.

2. The air bag module of claim 1 wherein the air bag module is disposed proximate a vehicle instrument panel.

3. The air bag module of claim 1 wherein the tear panel further comprises a first end portion and a second end portion disposed opposite the first end portion, the first and second end portions being coupled to the housing when the air bag is in the stored condition.

4. The air bag module of claim 3 wherein the tear panel further comprises first and second unattached edges extending between the first and second end portions, the first and second end portions cooperating with the housing to define first and second openings before the tear panel tears.

5. The air bag module of claim 4 wherein the tear panel includes a weakened area extending between the first and second unattached edges.

6. The air bag module of claim 1 wherein the tear panel includes a weakened area having a tear initiator adapted to tear before an adjacent portion of the weakened area.

7. The air bag module of claim 1 wherein the tear panel cooperates with the housing to define first and second openings through which the air bag expands before the tear panel tears.

8. The air bag module of claim 7 wherein the first and second openings are disposed opposite each other.

9. The air bag module of the claim 7 wherein the tear panel further comprises a weakened area, a first tear initiator disposed proximate the first opening, and a second tear initiator disposed proximate the second opening, the first and second tear initiators being adapted to initiate tearing of the weakened area before adjacent portions of the weakened area.

10. An air bag module for a motor vehicle, the air bag module comprising:
a housing configured to be mounted on the motor vehicle;
an air bag disposed proximate the housing;
an inflator configured to provide an inflator gas to inflate the air bag from a stored condition to a deployed condition; and
a tear panel disposed proximate the housing, the tear panel having first and second unattached edges that cooperate with the housing to define first and second openings, respectively, when the air bag is in the stored condition, the tear panel including a weakened area adapted to tear when the air bag is actuated toward the deployed condition;
wherein the tear panel directs deployment of the air bag through the first and second openings and away from a vehicle occupant before the weakened area tears.

11. The air bag module of claim 10 wherein the housing further comprises a set of retaining features adapted to receive the tear panel.

12. The air bag module of claim 11 wherein each member of the set of retaining features is configured as a hook.

13. The air bag module of claim 11 wherein the tear panel further comprises a set of attachment slots, each member of the set of attachment slots being adapted to engage a member of the set of retaining features before the weakened area tears.

14. The air bag module of claim 13 wherein a weakened area is disposed proximate each member of the set of attachment slots, the weakened areas being adapted to tear to permit each member of the set of attachment slots to disengage a member of the set of retaining features.

15. The air bag module of claim 11 wherein the housing further comprises first and second sets of retaining features and the tear panel further comprises a first set of attachment slots disposed near a first end portion and a second set of attachment slots disposed near a second end portion, the first and second sets of attachment slots being adapted to engage the first and second sets of retaining features, respectively, when the air bag is in the stored condition.

16. An air bag module for a motor vehicle, the air bag module comprising:
a housing configured to be disposed proximate the motor vehicle;
an air bag disposed proximate the housing;
an inflator configured to provide an inflator gas to inflate the air bag; and
a tear panel having first and second coupling portions disposed proximate the housing when the air bag is deflated and a weakened area adapted to tear when the air bag is inflated;
wherein the tear panel extends along an arcuate path between the first and second coupling portions and the tear panel cooperates with the housing to define first and second openings through which the air bag deploys when the air bag is inflated and before the weakened area tears.

17. The air bag module of claim 16 wherein the tear panel further comprises first and second unattached edges extending between the first and second coupling portions and disposed proximate the first and second openings, respectively, the first and second unattached edges cooperating with the housing to define the first and second openings.

18. The air bag module of claim 17 wherein the first coupling portion is disposed opposite the second coupling portion and the first unattached edge is disposed opposite the second unattached edge.

19. The air bag module of claim 16 wherein the air bag further comprises a first portion and a second portion, the first portion extending through the first opening and the second portion extending through the second opening before the air bag is inflated to facilitate deployment of the air bag away from a vehicle occupant before the weakened area tears.

20. The air bag module of claim 19 wherein the tear panel further comprises an inner surface and an outer surface disposed opposite the inner surface, and wherein the first and second portions are disposed proximate the outer surface before the air bag is inflated.
